(19) United States
(12) Patent Application Publication
(10) Pub. No.: US 2014/0127110 A1
(43) Pub. Date: May 8, 2014

(54) METHOD FOR RECOVERING PHOSPHORUS IN THE FORM OF A COMPOUND CONTAINING PHOSPHORUS, FROM LAMP WASTE CONTAINING LUMINOPHORES

(71) Applicants: Thomas Huckenbeck, Augsburg (DE); Robert Otto, Stadtbergen (DE)

(72) Inventors: Thomas Huckenbeck, Augsburg (DE); Robert Otto, Stadtbergen (DE)

(73) Assignee: OSRAM GmbH, Muenchen (DE)

(21) Appl. No.: 14/118,242

(22) PCT Filed: May 11, 2012
(86) PCT No.: PCT/EP2012/058784

§ 371 Date: Jan. 23, 2014

(30) Foreign Application Priority Data
May 18, 2011 (DE) 10 2011 076 038.5

(51) Int. Cl. C01B 25/18

(52) U.S. Cl. CPC C01B 25/18
USPC 423/299

(57) ABSTRACT

A method for recovering phosphorus as a compound containing phosphorus from lamp waste, which contains luminophores, wherein a part, more than 20 wt.-%, of the luminophores are luminophores containing phosphorus, the method may include: a) mechanically partitioning out of coarse components; b) partitioning out of luminophores containing phosphorus as a dissolving process; c) separating the phosphorus; d) optionally carrying out at least one purification; and e) performing optional final treatment.

### RELATED APPLICATIONS

This application is a national stage entry according to 35 U.S.C. §371 of PCT application No.: PCT/EP2012/058784 filed on May 11, 2012, which claims priority from German application No.: 10 2011 076 038.5 filed on May 18, 2011.

### TECHNICAL FIELD

The present disclosure is directed to a method for recovering phosphorus in the form of a compound containing phosphorus, from lamp waste containing luminophores. In particular, this refers to a method for reclaiming phosphoric acid from luminophore lamp waste. Such methods are suitable in particular for linear luminophore lamps, but also for compact luminophore lamps.

### BACKGROUND

Luminophore lamp waste has heretofore often been landfilled as hazardous waste. The currently known method approaches for preparing luminophore lamp waste primarily describe methods which have the goal of reclaiming the individual components, in particular luminophores containing rare earth elements.

EP 2 027 591 describes a method, based on multistep acid leaching with subsequent precipitation of rare earth elements using oxalic acid. In the first step, the halophosphate is partitioned from the three-band luminophore mixture. The remaining rare earth-luminophore mixture is again treated using an acid at at least 90° C. Rare earth oxides are precipitated from the filtrate by adding oxalic acid as a mixed oxalate.

### SUMMARY

Various embodiments provide a method which permits the reclamation of phosphoric acid during the recycling of luminophore lamp waste for use in luminophore production. In addition to the use in luminophore production, the phosphoric acid can also be used for other purposes.

Methods for reclaiming phosphorus compounds, for example, phosphoric acid, in conjunction with the recycling of luminophore lamp waste are not previously known. The luminophore lamp waste or residual waste have heretofore been largely landfilled as hazardous waste. The reclamation of phosphorus compounds in the form of digestion of phosphate-containing minerals such as monazite or also bastnaesite is also not known.

The novel method is, using economically acceptable means, to achieve the required quality, which permits unrestricted reuse of the preparation products containing phosphorus, whether for lamp production or, for example, for fertilizers or for food or also other applications.

A fraction containing luminophore, which is separated from the lamp bulb, arises during the recycling of luminophore lamp waste. The luminophore powder of this fraction consists of a mixture of greatly varying luminophores. Predominantly, it contains halophosphate luminophores, three-band luminophores, and special luminophores. Furthermore, the fraction contains glass splinters and metal parts and is contaminated with mercury, and the contamination is of varying strength depending on the batch. Directly returning reclaimed material into the production process is therefore not possible. The quantity of fractions containing luminophore waste is approximately 250 to 300 tons per year in Germany. These quantities have heretofore been stored in underground landfills, i.e., not recycled at all, because of the toxicity thereof and because of inadequate processing capabilities.

Because of the proportion contained therein of halophosphate luminophores, depending on the lamp type typically 10% up to 100 wt.-%, fractions containing luminophore waste represent a significant raw material potential for the production of phosphoric acid or phosphates.

With regard to sustainable operations, it is crucial to supply the luminophore waste to regulated recycling. The goal is to develop a method, using which it is possible to reclaim phosphorus products, preferably phosphoric acid or phosphate compounds, in a quality which corresponds to the phosphorus products produced from natural raw materials (e.g., guano, diverse minerals), so they can thus be used unrestrictedly, e.g., for fertilizers, for the food industry, or for luminophore production.

Essential considerations in conjunction with the novel method are as follows:
firstly the quantitative and qualitative determination of the material composition of the waste containing luminophores, in particular the phosphate content thereof and the included contaminants, as is fundamentally known;
utilization of mechanical methods to enrich luminophores containing phosphates by partitioning out contaminants (for example, glass splinters), as is fundamentally known;
development of an extraction method for the most quantitative reclamation possible of phosphorus or a phosphorus compound such as phosphate;
in particular the preparation of the extracted phosphorus compound in a manner suitable for further processing, wherein the further processing is performed to produce products, the quality of which corresponds to commercially available raw materials, in particular for luminophore production;
all method steps can be optimized in particular in consideration of residual material from already existing generated waste.

The goal of the newly developed method is in particular to obtain phosphorus products, in particular phosphorus compounds, for example, phosphoric acid, according to various partitioning, dissolving, digesting, and separating processes, wherein the properties and usability thereof correspond to the products containing phosphorus which are produced from the typical raw materials.

The old luminophore is a mixture of different luminophores, the main components of which are halophosphate luminophores and/or three-band luminophores containing rare earth elements. This luminophore mixture is part of a fraction, which is contaminated above all with lamp components such as bulb glass, metal parts (coil, power supply lines, base), plastic parts (base, insulation), and putty. Depending on the origin and pretreatment of the old luminophore, mercury contamination can also be present, values for mercury up to 20 000 ppm are typical. Pretreatment in particular by the preparatory method step of so-called demercurization is typical.

A demercurized material is presumed hereafter. The residual content of mercury thereof is at most still 3 ppm. This step of reducing the mercury proportion must possibly be put first.

Typical weight proportions of the fraction having demercurized old luminophore, which can be divided into fine fraction and coarse fraction, are:

| component | proportion in wt.-% |
|---|---|
| coarse fraction | 65-75%, typically 70% |
| fine fraction | 25-35%, typically 30% |
| thereof phosphorus: (as P₂O₅ in | up to 45% (depending on the |
| the fine fraction) | starting material) |
| thereof rare earth elements: | approximately 10% (depending |
| (as RE oxides in the fine | on the starting material) |
| fraction) | |

The processing steps of partitioning, dissolving, digesting, and separating can be combined or varied as desired depending on the luminophore types present in the old luminophore and quantity proportions thereof.

The poorly-soluble residues (e.g., glass, three-band luminophores) are also partitioned out by completely dissolving luminophore components containing phosphorus.

The process can be constructed from the following steps. They can be combined as desired.

The individual process steps for the material with mercury removed are as follows:
mechanical partitioning out of coarse components;
partitioning out of the luminophore components containing phosphorus, in particular present as a halophosphate, by means of two alternative routes, which can also be connected one after another:
   cold acid treatment;
   hot acid treatment;
separation of phosphorus or phosphorus compound;
final treatment, if necessary.

The mechanical partitioning out of coarse components is carried out in a first step, which includes in particular sieving or the step of sieving.

Firstly, coarse residual components of the discarded luminophore lamps, such as glass splinters, metal residues, plastic residues, or putty residues, are mechanically removed in particular.

Since luminophores typically have a mean grain size of d₅₀<10 μm and d₉₀<30 μm, the residual waste is sieved with the smallest possible mesh width to achieve the best possible enrichment with respect to phosphorus.

The sieving can be executed in one or multiple steps depending on the method.

The mesh width of the finest sieving is dependent on the method used and is typically at less than 70 μm mesh width, wherein the mesh width is also dependent on the sieving method used, wherein preferably dry vibration sieving is applied.

The fine material obtained therefrom is further processed using chemical methods.

The partitioning out of the halophosphate or another luminophore containing phosphorus from the fine material is performed by acid treatment. Luminophores containing phosphate, predominantly these are halophosphate luminophores, easily dissolve in acids, in particular hydrochloric acid or sulfuric acid, and can be dissolved using one of the methods described hereafter, for example.

A first embodiment of the acid treatment is the treatment at low temperatures in the range up to 30° C., in particular in the range from 10 to 30° C. This is designated as cold acid treatment.

In the temperature range below 30° C., luminophores containing phosphate, for example halophosphate, are dissolved well. Yttrium-europium oxide, the luminophore which has the best acid solubility of the group of the three-band luminophores, in contrast, is not attacked or is only slightly attacked. The remaining components are largely resistant under these conditions and remain in the insoluble solid residue.

After solid-liquid partitioning by filtration, the filtrate containing phosphorus is supplied to the phosphorus recovery.

The residue, which primarily consists of poorly-soluble rare earth luminophores, can be processed separately, for example, as described in detail in EP 2 027 591.

A second embodiment of the acid treatment is the treatment at high temperatures in the range above 30° C., in particular in the range of 50 to 120° C. This is designated as hot acid treatment.

In the temperature range between 30° C. and typically 90° C., luminophore containing phosphate, for example halophosphate, is dissolved increasingly completely, in particular from 50° C. In addition, yttrium-europium oxide, the most easily acid-soluble three-band luminophore, is dissolved increasingly completely. The remaining components are largely resistant under these conditions and remain in the insoluble residue.

After the solid-liquid partitioning by filtration, the rare earth ions still contained in the filtrate are partitioned out, e.g., by oxalate precipitation or ion exchanger methods, and the remaining filtrate containing phosphorus is supplied to the phosphorus reclamation.

The residue, which primarily consists of poorly-soluble rare earth luminophores, can be processed separately, for example, by digestion as described in greater detail in EP 2 027 591. The separation of the phosphorus is performed in the next step. Firstly, a first purification step of the filtrate is performed. If partitioning out of contaminants typical to luminophores, e.g. CL⁻, F⁻, Mn²⁺, Sb³⁺, is necessary or advantageous, different methods can be used for this purpose, e.g. precipitation reactions or ion exchanger methods.

If this purification step is not sufficient to achieve the desired properties of the filtrate, for example with regard to purity or concentration, phosphorus, preferably as a phosphorus compound such as phosphate, is obtained from the acid aqueous solution of the filtrate by liquid-liquid extraction. Organic compounds, such as in particular TBP=tributyl phosphate, sometimes in conjunction with solvents, e.g. kerosene or petroleum, are typically used as the extraction agents.

If the phosphorus compound which is present in the filtrate is phosphoric acid, it can be decomposed by thermal methods or by wet-chemistry methods. The highest purity can be achieved using thermal methods. Pure phosphoric acid is applied, which is then ignited. Wet-chemical methods primarily use apatite (haloapatite) as the starting base in the residual waste. For the dissolving, an acid is used with application of liquid-liquid extraction. Haloapatite is often Ca₁₀(PO₄)₆FₓCl₂₋ₓ. It often also contains antimony or manganese as an activator. It is then Ca_{10-a-b-n}SbₐMn_{b}(PO₄)₆FₓCl₂₋ₓ. Typically, a and b are in the range from 0 to 2 and n is from 0 to 1. The value n expresses a possible substoichiometric formulation.

Luminophores containing phosphate of the type halophosphates are described in EP 1 306 885. They are typically doped using antimony and/or manganese. In this case, ions such as antimony and manganese must be precipitated and either enter the wastewater or are recycled via a sulfite route. In any case, these ions must be removed from the phosphorus compound, preferably in a step of partitioning out after hot acid treatment.

Further luminophores containing phosphate and rare earth metals are three-band luminophores, which contain, for example, lanthanum from LAP (provided as monazite), see WO 2011/012508. Further luminophores which contain phosphorus are phosphates of the alkaline earth metals such as strontium apatite Sr3(PO4)2:Sn, see WO 2008/071206 or GB 2 411 176. Also in the case of these luminophores, H3PO4 can be recovered to obtain P2O5 therefrom. Further

The novel method fundamentally permits phosphoric acid to be obtained in food quality, not only for fertilizers. The length of the column is decisive for the quality or purity of the phosphoric acid, see, for example, DE-A 1 769 005.

The novel method applies columns in particular for the liquid-liquid extraction of phosphoric acid. The phosphoric acid obtained in this case is typically 98% pure.

The organic solution, also called the organic phase or organic matter, stands in the column in addition to H3PO4 in a column over strongly diluted phosphoric acid. Distilled water is used for the dilution.

Depending on the (residual) contaminants present, ion exchanger resins may also be used for the separation of phosphorus as phosphoric acid.

Finally, a step of final treatment is optionally performed.

If a final treatment of the resulting secondary products is necessary and has not already been performed during the individual process steps, wastewater treatment is carried out according to the typical prior art.

For the purpose of the most complete possible luminophore recycling, residues should be processed further, if they contain concentrations of rare earth metals of economic interest.

The luminophore powder arises as a separated fraction during the luminophore lamp utilization. The luminophore waste containing mercury is classified as “waste requiring special monitoring” and must be stored as hazardous waste. The targeted recycling process described here reduces mass and volume of the hazardous waste provided for landfilling. This contributes to reducing the transport and landfilling costs and to relieving the landfill and protecting the human habitat.

The luminophore waste represents a valuable potential raw material because of the ingredients thereof, above all phosphates and rare earth elements.

The described method permits the heretofore not performed recovery of phosphorus from lamp luminophores, preferably as phosphoric acid. The exhaustion of the natural resources, which is already currently noticeable, in particular of phosphorus here, is thus counteracted.

The further processing of the residues containing rare earth elements, which arise during the reclamation of phosphorus, for example luminophores or solutions thereof, for the recycling of rare earth metals, has already been described in EP 2 027 591.

Phosphorus and rare earth element reclamation permits the processing of a majority of the powdered waste arising during luminophore lamp recycling.

The cost-effectiveness of the lamp recycling is additionally increased further by the reclamation of phosphorus.

Luminophore recycling is advisable not only for ecological reasons, but rather also for economic reasons. In addition to important raw materials, the energy required for obtaining raw materials is also saved.

The residual waste materials arising during the recycling process of the luminophore waste are less environmentally harmful than the primary luminophore powder arising during the lamp utilization.

This reduction of the harmful materials makes the disposal of these residual waste materials easier.

The novel recycling technology described here corresponds to the requirements of current waste disposal. Luminophore recycling helps in the construction of modern recycling systems, wherein cycles of materials are closed in a cost-effective and environmentally friendly manner.
A method for recovering phosphorus as a compound containing phosphorus from lamp waste, which contains luminophores, wherein a part, in particular more than 20 wt.-%, of the luminophores are luminophores containing phosphorus, in particular halophosphates is disclosed. The method includes:
   a) mechanical partitioning out of coarse components;
   b) partitioning out of luminophores containing phosphorus as a dissolving process, in particular by acid treatment;
   c) separation of the phosphorus;
   d) optionally carrying out at least one purification step;
   e) optional final treatment.
In a further embodiment, the method is configured such that b) is performed at temperatures between 10 and 150° C.
In a still further embodiment, b) includes a cold acid treatment at temperatures of at most 30° C.
In a still further embodiment, b) includes a hot acid treatment at temperatures of at least 50° C.
In a still further embodiment, a) includes at least one sieving using a mesh width which is at most 200 μm, in particular at most 70 μm.
In a still further embodiment, b) is carried out as a liquid-solid partitioning, wherein a filtrate containing phosphorus remains.
In a still further embodiment, the filtrate is subjected to a step of partitioning out RE ions, in particular by oxalate precipitation or by ion exchanger, whereby a more highly concentrated filtrate containing phosphorus remains.
In a still further embodiment, in c), the filtrate containing phosphorus is provided as an acid aqueous solution, from which the phosphorus is separated.
In still further embodiment, in c), ion exchanger resins are used for the separation of the phosphorus.
In still further embodiment, after c), in a purification d), contaminants typical to luminophores are partitioned out.
In a still further embodiment, after c), in a purification d), a compound containing phosphorus is obtained by liquid-liquid extraction from the acid aqueous solution.
In a still further embodiment, an organic compound is used as the agent for extraction.

### BRIEF DESCRIPTION OF THE DRAWINGS

In the drawings, like reference characters generally refer to the same parts throughout the different views. The drawings are not necessarily to scale, emphasis instead generally being replaced upon illustrating the principles of the disclosure. In the following description, various embodiments of the disclosure are described with reference to the following drawings, in which:

FIG. 1 shows a sequence diagram for luminophore recycling according to the disclosure;

FIGS. 2 to 5 each show an alternative sequence diagram; and

FIG. 6 shows a detail of an extraction by means of three columns connected in series.

### DETAILED DESCRIPTION

The following detailed description refers to the accompanying drawings that show, by way of illustration, specific details and embodiments in which the disclosure may be practiced.

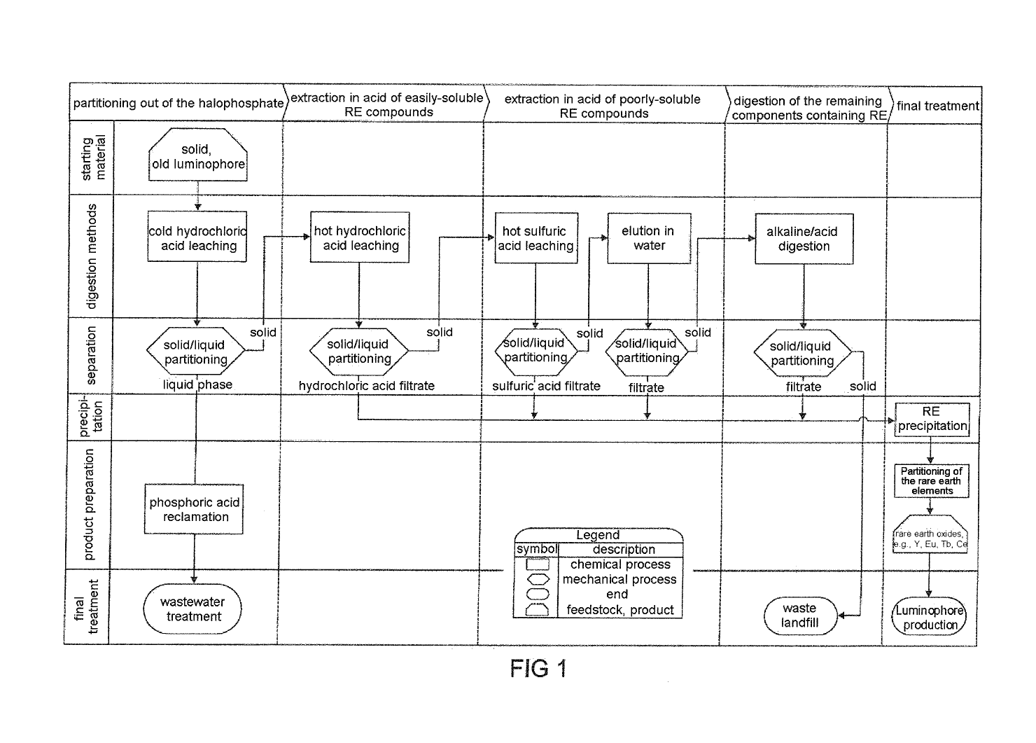

FIG. 1 shows a diagram for the sequence of the recycling. Halophosphate, represented here as a single luminophore containing phosphorus, is partitioned out from the collected old luminophore in the first step of the method by cold leaching. The extraction of the rare earth elements is performed depending on the solubility of the compounds present in three separate steps. The liquid phases are collected and processed further to form rare earth elements. The partitioned-out halophosphate is separated further.

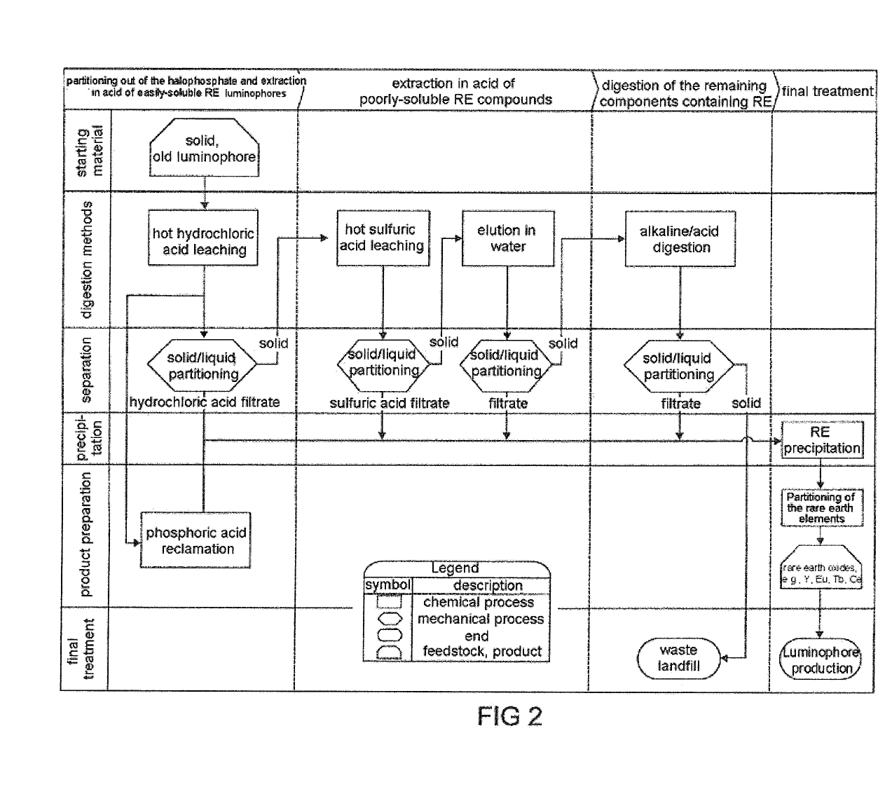

FIG. 2 shows a further embodiment of the sequence of the recycling. In contrast to diagram 1, halophosphate and easily-soluble luminophores containing rare earth elements are dissolved together by means of hot hydrochloric acid leaching. This is followed by the digestion of the poorly-soluble rare-earth luminophores in two steps. The partitioned-out halophosphate is separated further.

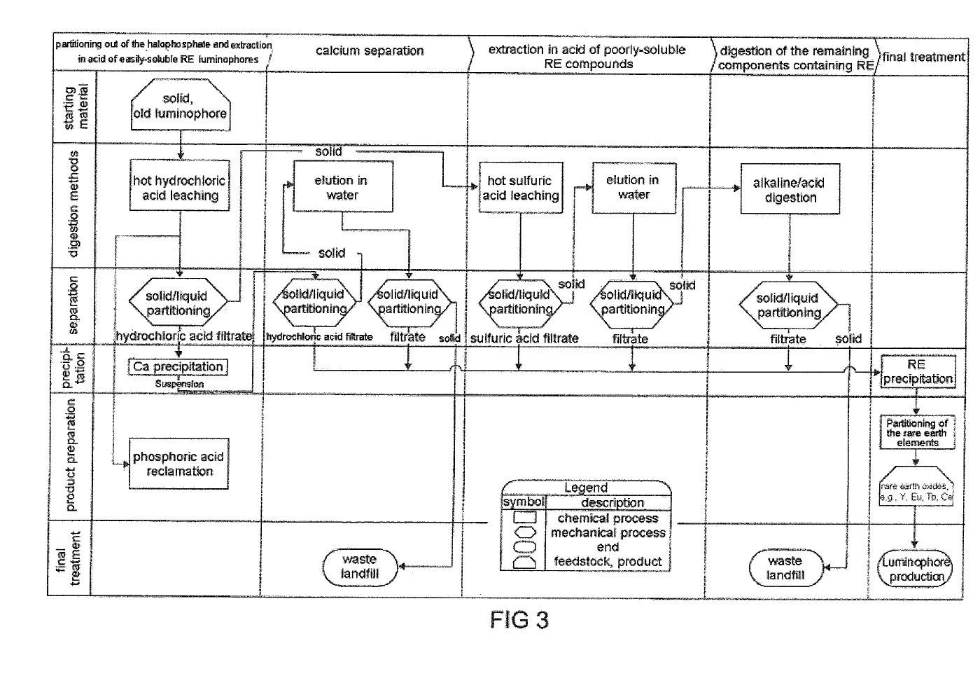

FIG. 3 shows a third exemplary embodiment of the sequence of the recycling. In contrast to diagram 2, after the dissolving of halophosphate and easily-soluble luminophores containing rare earth elements, calcium ions are partitioned out. The partitioned-out halophosphate is separated further.

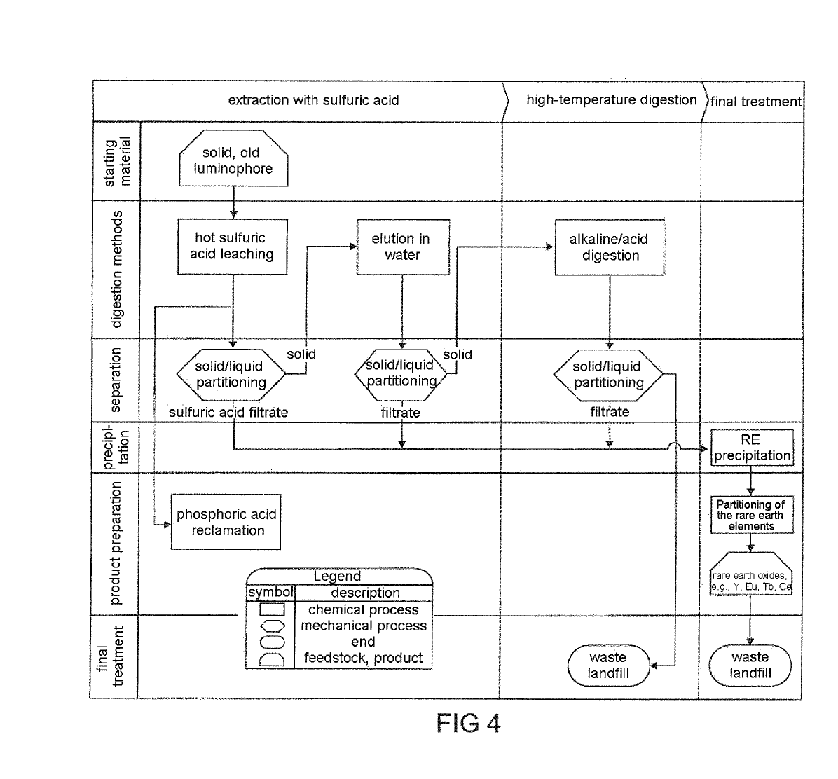

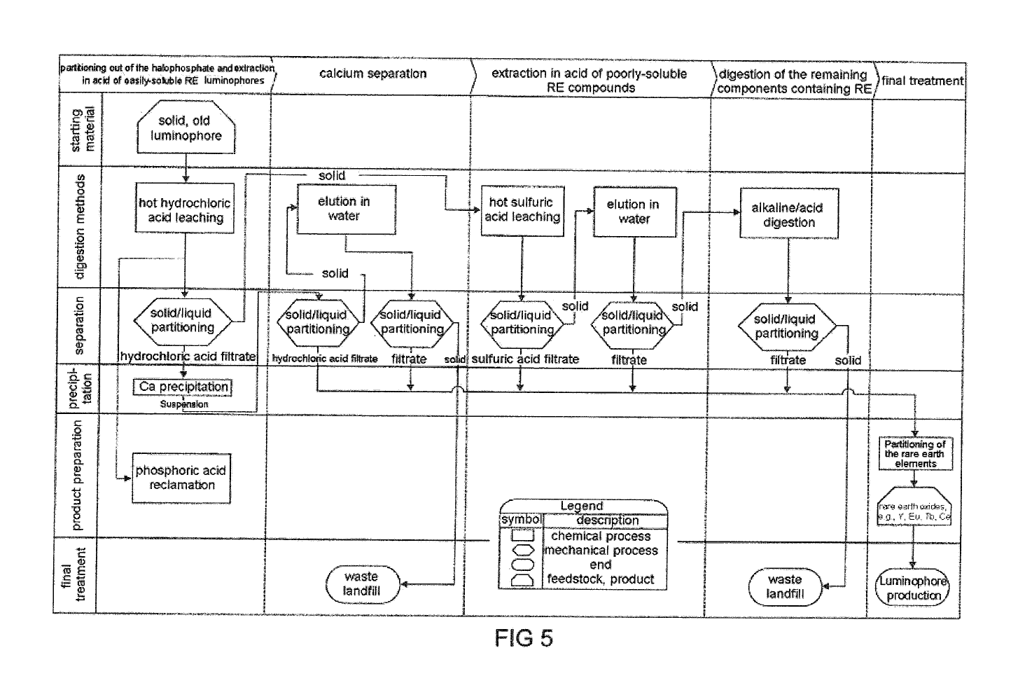

FIG. 4 shows a fourth embodiment of the sequence of the recycling. In contrast to diagrams 1 to 3, in the first step, both compounds which are easily soluble and also compounds which are poorly soluble in acid are digested and simultaneously calcium ions are partitioned out. The partitioned-out halophosphate is separated further. FIG. 5 shows a further embodiment. In principle, it is possible and, in the case of specific luminophores in the recycling luminophore, also advisable, during the extraction of the RE in multiple steps, not to mix the liquid phase containing RE with others, but rather to process it further separately. In the case of corresponding preconditions (e.g., extraction of the RE from the recycling luminophore and RE partitioning step at the same location), direct partitioning without prior precipitation and annealing is preferable. The partitioned-out halophosphate is separated further.

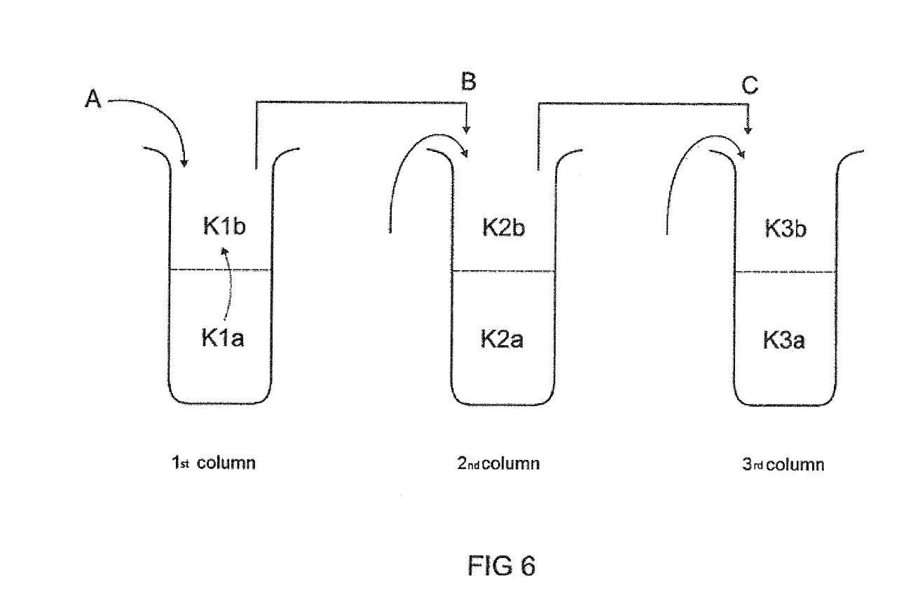

The novel method applies columns in particular for the liquid-liquid extraction of phosphoric acid, see FIG. 6. The phosphoric acid obtained is typically 98% pure.

The organic solution, also called organic phase or organic matter, stands in the column in addition to H3PO4 in a column over strongly diluted phosphoric acid. Distilled water is used for the dilution.

Firstly, organic solution (K1b) is decanted into a first column. In this column, 40 to 50% phosphoric acid H3PO4 is decanted as a liquid (A), which additionally initially also contains the contaminants typical for old luminophores, such as manganese ions or antimony ions as a residue. In the first column, the liquids partition themselves, for example in countercurrent. Predominantly water stands at the bottom as the first section (K1a), the organic solution stands above it as the second section (K1b). H3PO4 travels from the lower subregion (K1a) into the organic matter. The foreign ions in the lower subregion (K1a) only travel however to a small extent into the second section, which is located above it, of the first column. In the final effect, water and a first part of the residue remains in the lower (K1a) first section. An organic solution stands above it as the second section (K1b), which contains the decanted H3PO4 and only still a second part of the residue. The H3PO4 contained therein is also significantly purer.

The further purification is performed in a second column. Firstly water having a pH value<7 is decanted therein. Organic solution from the second section of the first column is decanted into this second column as the second liquid (B), i.e., containing 40-50% already partially purified phosphoric acid, H3PO4, which only still contains a second part of the contaminated residue, such as manganese ions or antimony ions. The liquids again partition themselves in the second column. H3PO4 remains in the organic matter, while the foreign ions travel into the second section (K2a). In the final effect, water and the residue of foreign ions remain on the bottom in the section (K2a). An organic solution stands above it as the second section (K2b), which contains the purified H3PO4.

The extraction of the H3PO4 is performed in a third column. Firstly water is decanted therein. Subsequently, organic solution from the second section of the second column is decanted therein as the liquid (C), i.e., containing phosphoric acid H3PO4, which contains practically no part of the residue, for example manganese ions or antimony ions. The liquids again partition themselves in the column, so that finally the desired high-purity H3PO4 and water remain in the lower section (K3a). Relatively pure organic matter stands above it as the second section (K3b).

The high-purity H3PO4 can then be processed further.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A method for recovering phosphorus as a compound containing phosphorus from lamp waste, which contains luminophores, wherein a part, more than 20 wt.-%, of the luminophores are luminophores containing phosphorus, the method comprising:
a) mechanically partitioning out of coarse components;
b) partitioning out of luminophores containing phosphorus as a dissolving process;
c) separating the phosphorus; and
d) optionally carrying out at least one purification.

2. The method as claimed in claim 1, wherein b) is performed at temperatures between 10 and 150° C.

3. The method as claimed in claim 2, wherein b) comprises a cold acid treatment at temperatures of at most 30° C.

4. The method as claimed in claim 2, wherein b) comprises a hot acid treatment at temperatures of at least 50° C.

5. The method as claimed in claim 1, wherein a) comprises at least one sieving using a mesh width which is at most 200 μm.

6. The method as claimed in claim 1, wherein b) is carried out as a liquid-solid partitioning, wherein a filtrate containing phosphorus remains.

7. The method as claimed in claim 6, wherein the filtrate is subjected to partitioning out RE ions whereby a more highly concentrated filtrate containing phosphorus remains.

8. The method as claimed in claim 1, wherein in c), the filtrate containing phosphorus is provided as an acid aqueous solution, from which the phosphorus is separated.

9. The method as claimed in claim 1, wherein in c), ion exchanger resins are used for the separation of the phosphorus.

10. The method as claimed in claim 8, wherein after c), in at least one purification d), contaminants typical to luminophores are partitioned out.

11. The method as claimed in claim 8, wherein after c), in at least one purification d), a compound containing phosphorus is obtained by liquid-liquid extraction from the acid aqueous solution.

12. The method as claimed in claim 11, wherein an organic compound is used as the agent for extraction.

13. The method as claimed in claim 1, further comprising
e) performing a final treatment.

14. The method as claimed in claim 1, further comprising:
e′) determining whether to perform a final treatment; and
e″) performing a final treatment depending on said determination.
